(19) United States
(12) Patent Application Publication
(10) Pub. No.: US 2018/0259493 A1
(43) Pub. Date: Sep. 13, 2018

(54) COMPREHENSIVE 2DGC SYSTEM COMPRISING OF A MODULATION COLUMN, A MODULATOR, AND A GAS CHROMATOGRAPH

(71) Applicant: J&X Electronic Technology (Shanghai) Co., Ltd., SHANGHAI (CN)

(72) Inventors: XIAOSHENG GUAN, SHANGHAI (CN); QIANG XU, SHANGHAI (CN)

(73) Assignee: J&X Electronic Technology (Shanghai) Co., Ltd.

(21) Appl. No.: 15/884,360

(22) Filed: Jan. 30, 2018

(30) Foreign Application Priority Data
Mar. 13, 2017 (CN) 201710154579.0

(51) Int. Cl. G01N 30/46; G01N 30/56; G01N 30/54; G01N 30/02

(52) U.S. Cl. CPC G01N 30/46; G01N 30/56; G01N 2030/025; G01N 2030/567; G01N 30/54

(57) ABSTRACT

A comprehensive two-dimensional gas chromatography system comprising of a sample inlet, a primary dimension column, a secondary dimension column, a thermal modulator, and a detector. The thermal modulator has a first modulation position and a second modulation position. The sample inlet connects to the primary dimension column. The exit of the primary dimension column connects to the first modulation position via a fluidic path, the first modulation position connects to the second modulation position via a fluidic path, the second modulation position connects to the secondary dimension column via a fluidic path, and the exit of the secondary dimension column connects to the detector. The fluidic path between the exit of the primary dimension column and the inlet of the secondary dimension column is a modulation column.

### CROSS-REFERENCE TO RELATED APPLICATIONS

This application claims priority to Chinese Patent Application No. 201710154579.0 with a filing date of Mar. 13, 2017. The content of the aforementioned applications, including any intervening amendments thereto, are incorporated herein by reference.

### BACKGROUND OF THE PRESENT INVENTION

In conventional thermal modulation comprehensive two-dimensional gas chromatography systems, modulation is achieved either at the end of the primary dimension column or at the head of the secondary dimension column. The so-called thermal modulation refers to temperature switching performed either in-phase or out-of-phase, at two specific locations of the column at a fixed frequency, in order to trap and remobilize sample molecules flowing within the column in the direction of carrier gas. By actions of modulation, eluant from the primary dimension column is re-sampled multiple times, and is re-injected onto the secondary dimension column for additional separations.

Choice of the primary dimension column and the secondary dimension column are mostly based on considerations to achieve best orthogonal separations instead of on considerations to achieve best modulation performance. As a result, successful thermal modulation has long been relying on cryogenic fluids, such as LN2, LCO2, or various compressor cooling mechanisms to create very low temperatures (less than −60 C) for effective sample trapping within column. At these low temperatures, all organic stationary phases in analytical columns are frozen, losing their capabilities to interact with sample molecules. Trapping is solely attributed to condensation, which is a very expensive means of achieving thermal modulation.

The present invention achieves modulation in a modulation column between the primary dimension column and the secondary dimension column.

By using a different form of stationary phase coating in the modulation column than that in the primary and secondary dimension columns, sample molecules can be trapped effectively at much high cooling temperatures, and can also be remobilized effectively at reasonable heating temperatures.

### DESCRIPTION OF THE DRAWINGS

FIG. 1: Schematics of the disclosed comprehensive 2DGC system.

FIG. 2a: Comprehensive 2D chromatogram of a Fluid-Catalytic-Cracked gasoline using conventional thermal modulation on secondary dimension column.

FIG. 2b: Comprehensive 2D chromatogram of a Fluid-Catalytic-Cracked gasoline using conventional thermal modulation on un-coated modulation column.

FIG. 3: Comprehensive 2D chromatogram of a Fluid-Catalytic-Cracked gasoline using thermal modulation according to type I modulation column.

FIG. 4: Embodiment #1 of the present invention.

FIG. 5: Embodiment #2 of the present invention.

FIG. 6: Embodiment #3 of the present invention.

FIG. 7: Embodiment #4 of the present invention.

FIG. 8: Embodiment #5 of the present invention.

FIG. 9: Embodiment #6 of the present invention.

FIG. 10: Embodiment #7 of the present invention.

FIG. 11: Embodiment #8 of the present invention.

### DETAILED DESCRIPTION OF PREFERRED EMBODIMENTS

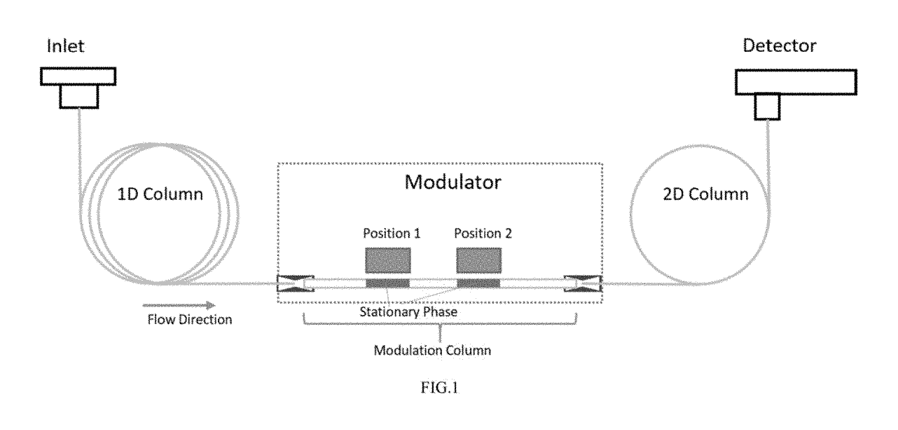

As depicted in FIG. 1, the present invention is a comprehensive 2D gas chromatography system that includes a sample inlet, a primary dimension column, a secondary dimension column, a thermal modulator, and a detector, wherein the sample inlet connects to inlet of the primary dimension column, the primary dimension column connects to the inlet of the modulator, the exit of the modulator connects to inlet of the secondary dimension column, and the exit of the secondary dimension column connects to the detector. The modulator has a modulation column of one of claims 1-9 configured within it.

The stationary phase in gas chromatography refers to a sorption layer in forms of solid particulates or liquid film coated on capillary column interior wall. The fluid path from the exit of the primary dimension column to the inlet of the secondary dimension column is called modulation column, and in present invention only part of length of the modulation column is coated with stationary phase. The modulation column is not limited in other aspects by the primary and secondary dimension columns, can be made of fused silica or metal. The length is typically between 3˜200 cm, and the inner diameter between 0.1˜0.53 mm. The physical and chemical properties of the stationary phase in the modulation column may be different from that in the primary and secondary dimension columns.

The modulation column is configured within the modulator. The modulator modulates on specific positions of the modulation column by means of cooling and heating. In general, there are first modulation position and second modulation position. The first modulation position is closer to the inlet of the modulator than the second modulation position, and the second modulation position is closer to the exit of the modulator than then first modulation position. The direction from the first modulation position to the inlet of the modulator is upstream direction. The direction from then second modulation position to the exit of the modulator is downstream position.

### Embodiment #1 of Present Invention

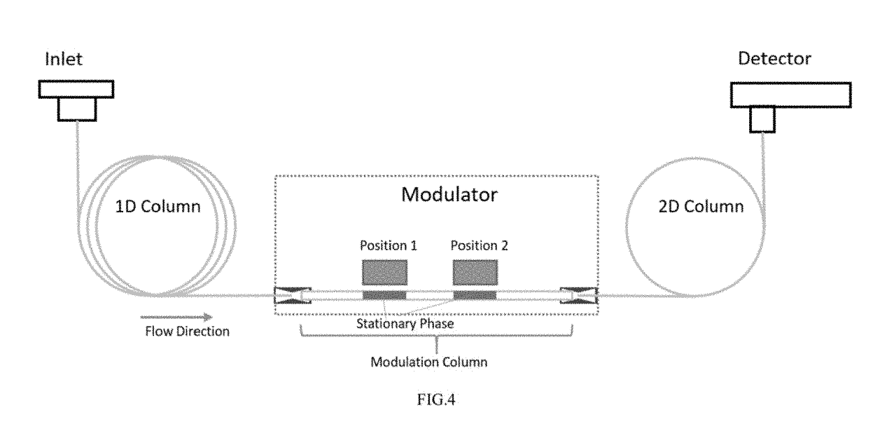

As shown in FIG. 4, only the first and second modulation positions of the modulation column is coated with stationary phase.

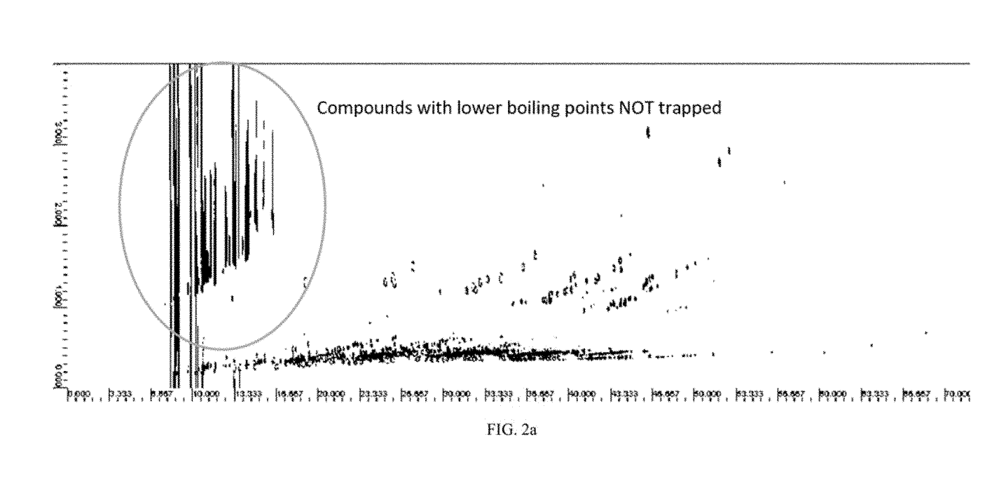

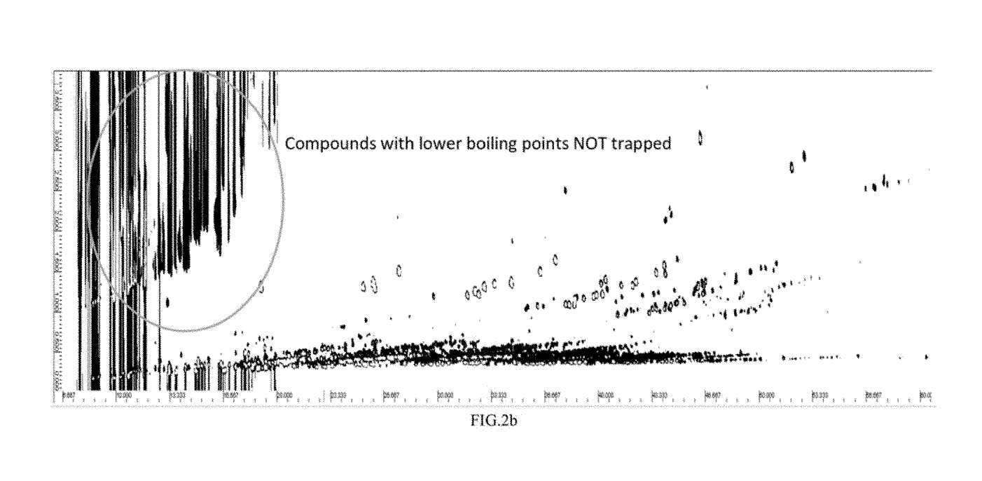

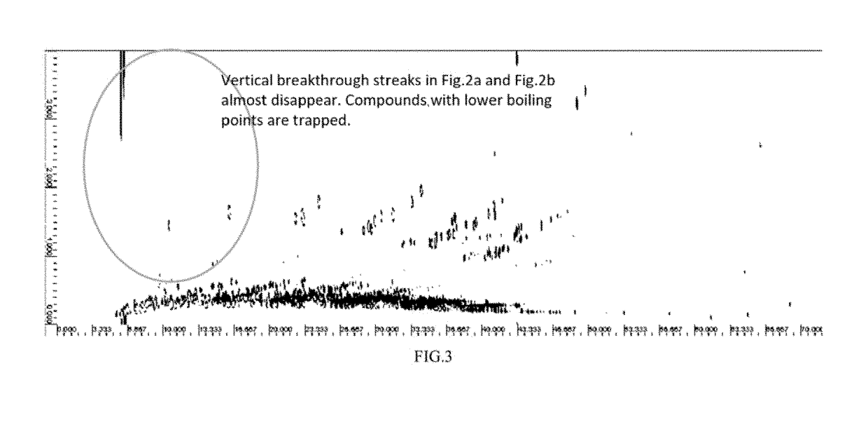

In general, the primary and secondary dimension columns of a comprehensive 2DGC system have relatively thin stationary phases that cannot effectively trap low boiling-point samples at mid-low temperatures. As shown in FIG. 2a, thermal modulation on the head of a secondary dimension column of 0.1 urn film thickness with a cooling temperature of −90 C can only trap compounds as volatile as Heptane. In contrast, embodiment #1 of present invention, using a modulation column with only two modulation positions coated with 1.0 um thick 100% polydimethylsiloxane stationary phase, can trap compounds as volatile as Pentane at a much higher cooling temperature of −50 C, as shown in FIG. 3. Advantage over un-coated modulation column is even more significant, as shown in FIG. 2b, where un-coated modulation column can only trap compounds as volatile as Nonane at the same cooling temperature of −50 C.

Coating the entire length of the modulation column with a thick layer of stationary phase would be, however, detrimental in several aspects and must be avoided: it may increase injection band width onto the secondary dimension column due to excessive post-modulation interaction of compounds with modulation column stationary phase, and it may affect elution order and pattern in the second dimension that is no longer attributed solely to the properties of the second dimension column.

### Embodiment #2

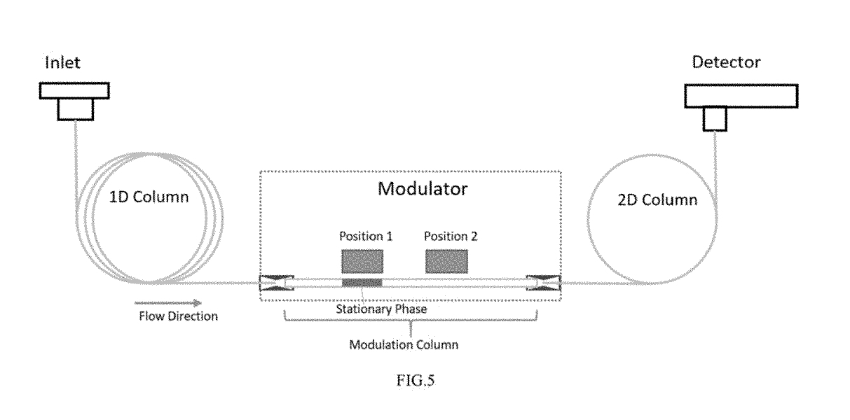

As shown in FIG. 5, only the first modulation position is coated with stationary phase.

This configuration is better than un-coated modulation column, but has a smaller modulation range than that of embodiment #1—it can only trap from Heptane at a cooling temperature of −50 C.

### Embodiment #3

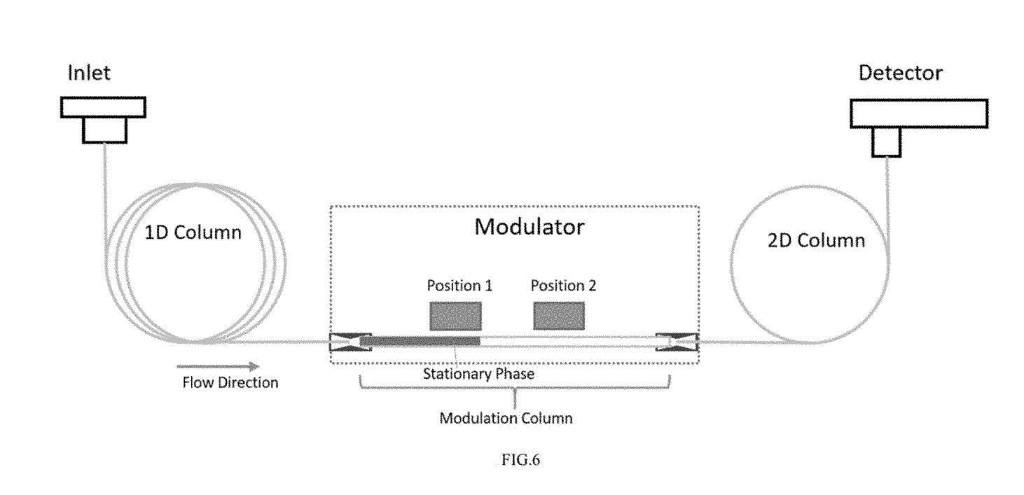

As shown in FIG. 6, only the first modulation position and a distance extending to upstream is coated with stationary phase. The coating may cover entire upstream length up to inlet of the modulation column.

This configuration has similar modulation performance to that of embodiment #2, but if the stationary phase is different from that of the primary dimension column, there could be some influence on first dimension elution order or pattern; on the other hand, it has a better inertness since less part of the modulation column is un-coated.

### Embodiment #4

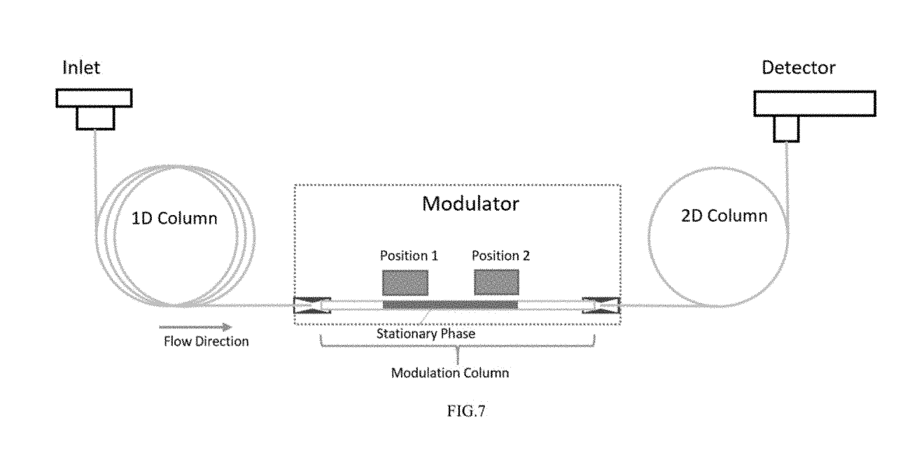

As shown in FIG. 7, only the first modulation position, the second modulation position, and the length between the two positions in the modulation column are coated with stationary phase. The coating is continuous.

This configuration has similar modulation performance to that of embodiment #1. A slight difference is that compounds remobilized from the first modulation position would take a longer time to arrive at the second modulation position due to interaction with the additional stationary phase length between the two modulation positions. It gives more time for the second modulation position to reach a cold enough temperature for better trapping.

### Embodiment #5

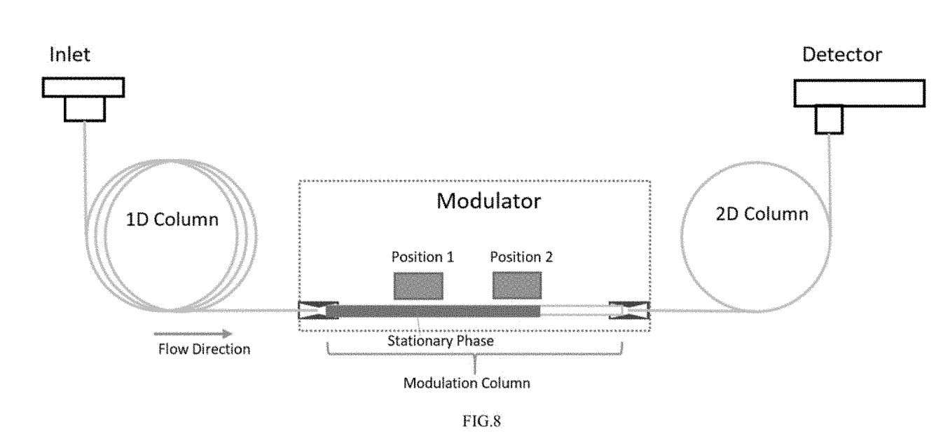

As shown in FIG. 8, only the first modulation position, the second modulation position, the length between the two modulation positions, and a distance extending to upstream of the first modulation position up to the inlet of modulation column, are coated with stationary phase. The coating is continuous.

This configuration has similar modulation performance to that of embodiment #4, but if the stationary phase is different from that of the primary dimension column, there could be some influence on first dimension elution order or pattern; on the other hand, it has a better inertness since less part of the modulation column is un-coated.

### Embodiment #6

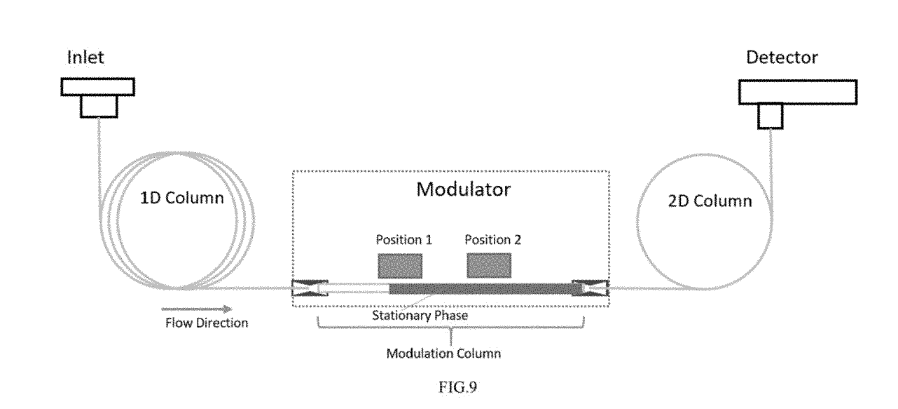

As shown in FIG. 9, only the first modulation position, the second modulation position, the length between the two modulation positions, and a distance extending to downstream of the second modulation position up to the exit of the modulation column, are coated with stationary phase. The coating is continuous.

This configuration has similar modulation performance to that of embodiment #4. A slight difference is that additional coating downstream of the second modulation position may be used to purposely increase secondary dimension peak widths in order to better fit to detectors of slower acquisition rates.

### Embodiment #7

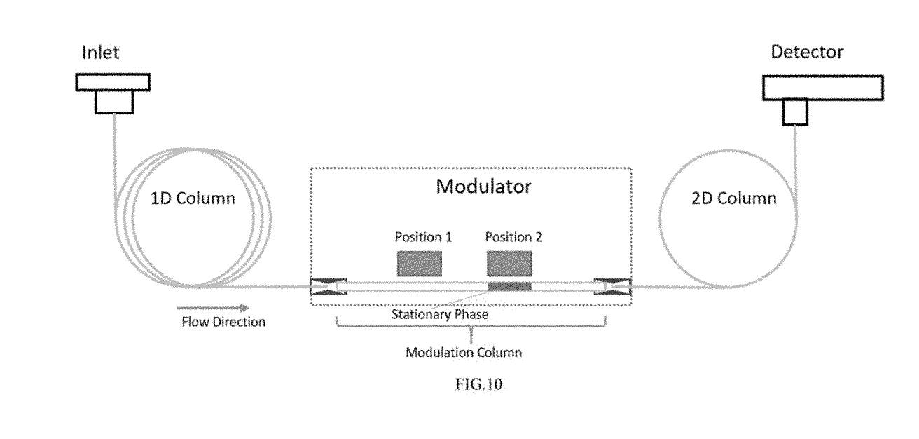

As shown in FIG. 10, only the second modulation position is coated with stationary phase in the modulation column.

This configuration has similar modulation performance to that of embodiment #2.

### Embodiment #8

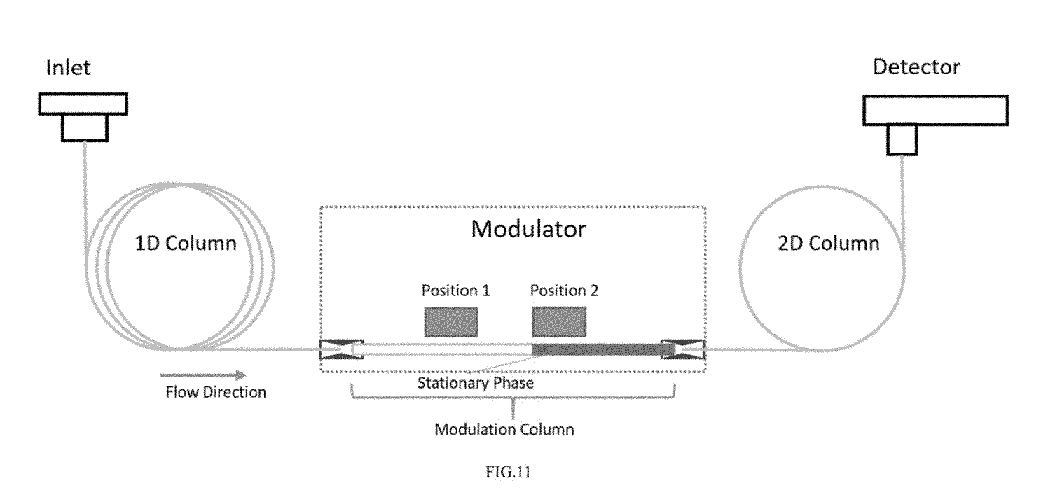

As shown in FIG. 11, only the second modulation position and a distance extending to downstream of the second modulation position up to the exit of the modulation column are coated with stationary phase.

This configuration has similar modulation performance to that of embodiment #7. A slight difference is that additional coating downstream of the second modulation position may be used to purposely increase secondary dimension peak widths in order to better fit to detectors of slower acquisition rates.

Stationary phase in the modulation column is chosen according to principles of ‘like dissolves like’. For example, if compounds to be analyzed are mostly non-polar, the stationary phase is generally 100% polydimethylsiloxane; if compounds to be analyzed are mostly polar, the stationary phase may be polyethylene glycol or ionic liquid. The stationary phase is not limited to the abovementioned materials. All types of gas chromatography stationary phases may be applied in the modulation column of present invention to achieve best modulation performance for specific applications.

In general, the thickness of the stationary phase in the modulation column is in the range of 0.05˜20 um. The thermal modulation may be achieved by cold and hot gas jets onto the first and the second modulation positions, or by relative movement between cold/hot means and the modulation column.

The modulation column in the above embodiments #1-#8 is an independent part from the primary and the secondary dimension columns. However, the modulation column may also be an integral part of the either the primary or the secondary dimension column.

We claim:

1. A modulation column used in a comprehensive two-dimensional gas chromatography system: the modulation column has only part of its length coated with a stationary phase. The modulation column is either an independent part from the primary dimension column and the secondary dimension column, or an integral part of the primary dimension column or the secondary dimension column.

2. The modulation column of claim 1, has a first and a second modulation positions, wherein (1) only the first and second modulation positions have stationary phase coating; or (2) only the first modulation position has stationary phase coating; or (3) only the first modulation position and a distance extending to its upstream has stationary phase coating; or (4) only the first modulation position, the second modulation position, and the length between these two positions have stationary phase coating; or (5) only the first modulation position, the second modulation position, the length between these two positions, and a distance extending to upstream of the first modulation position have stationary phase coating; or (6) only the first modulation position, the second modulation position, the length between these two positions, and a distance extending to downstream of the second modulation position have stationary phase coating; or (7) only the second modulation position has stationary phase coating; or (8) only the second modulation position and a distance extending to its downstream has stationary phase coating.

3. The modulation column of claim 2, wherein the distance described in the third and fifth variations extends to the inlet end of the modulation column.

4. The modulation column of claim 2, wherein the stationary phase coating described in the fourth, fifth, and sixth variations is continuous.

5. The modulation column of claim 2, when it is an integral part of the primary dimension column, it is the end part of the primary dimension column; when it is an integral part of the second dimension column, it is the end of part of the secondary dimension column.

6. The modulation column of claim 1, wherein the stationary phase coating is either non-polar or polar.

7. The modulation column of claim 1, wherein the stationary phase coating thickness is thicker than that of the primary dimension column and secondary dimension column.

8. The modulation column of claim 1, wherein the modulation column has a length of 3˜200 cm, an inner diameter of 0.1˜0.53 mm.

9. The modulation column of claim 1, wherein the first and second modulation positions are where chemical molecules are modulated by the thermal modulator. The first modulation position is closer to inlet of the thermal modulator than the second modulation position, the second modulation position is closer to exit of the thermal modulator than the first modulation position.

10. A modulator that has a modulation column of claim 1 configured within it.

11. A comprehensive two-dimensional gas chromatography system that includes a sample inlet, a primary dimension column, a secondary dimension column, a thermal modulator, and a detector, wherein the sample inlet connects to inlet of the primary dimension column, the primary dimension column connects to the inlet of the modulator, the exit of the modulator connects to inlet of the secondary dimension column, and the exit of the secondary dimension column connects to the detector. The modulator has a modulation column of claim 1 configured within it.
